(19) United States
(12) Patent Application Publication
(10) Pub. No.: US 2017/0098275 A1
(43) Pub. Date: Apr. 6, 2017

(54) METHOD AND DEVICE FOR DIRECT, AUTOMATIC BANK/CLIENT OPERATIONS

(71) Applicant: Adolfo Perez Escobar, Madrid (ES)

(72) Inventor: Adolfo Perez Escobar, Madrid (ES)

(21) Appl. No.: 14/874,487

(22) Filed: Oct. 5, 2015

(51) Int. Cl. G06Q 40/02; H04L 12/58; G06Q 30/02

(52) U.S. Cl. CPC G06Q 40/02; G06Q 30/0281; H04L 51/046

(57) ABSTRACT

Method and device for direct, automatic operations between bank and client whereby, with a simple click on a device installed in the client's domicile, a previously-arranged financial operation can be run, characterised because the resources for running the procedure are configured on the basis of the electronic device (HW) with pre-loaded software (17) and a communications algorithm (Ac), the device consisting of a straight, rectangular parallelepiped housing with rounded edges (7) on whose upper face a number of two-position keys are shown—(8a), (8b), (8c)—corresponding to the various options granted by the bank and, alongside each option key (8), the same number of light windows (9) each with two luminous leds, one green (11) and the other red (12), and showing a central button (13) which triggers the order and, on one side, a connection (14) to the electricity network.

### PURPOSE OF THE INVENTION

The invention these specifications refer to is for a method and a device for automatic, direct operations between bank and client so that a simple click of a device installed in the client's domicile allows a previously arranged financial operation to be carried out without need for travel, personal presence or negotiation.

A user linked to a bank by a device facilitated by the bank itself can instantaneously order a secure and verified transaction by a simple click of said device.

### FIELD OF THE INVENTION

The invention proposed affects not just the communications industry and the banking industry but in general the services industry and especially the hardware and software design industry.

### PRIOR ART

There are some remote predecessors referring to direct bank/client relations.

Of these, the following may be mentioned.

For example, patent WO2012203970 of Weiler Deter, called “Method for operating at least one data bank on a hardware pool”.

The invention refers to a method to operate at least one data bank on a hardware pool comprising of a multiplicity of elements, with resources, and made up of the following stages: a) to operate the data bank in a first configuration using at east a first portion of the resources in at least a first portion of the elements of the hardware pool, b) to control at least one of the following parameters: i) the hardware pool resources; ii) the resources of individual elements for each element of the hardware pool; iii) the load factor of the elements of the hardware pool; iv) the availability of the hardware pool elements; and v) el data bank's performance record; and c) an examination for at least one data bank as to whether said data bank can be operated with the parameter of at least one and compliance with a criterion that can be predetermined, in a second configuration of the use of at least a second portion of the resources of the hardware pool in at least a second portion of the elements of the hardware pool.

This method is characterised because in stage 1.c, at least one data bank is transferred to the second configuration, and operates from it.

This may indeed provide a remote predecessor but in no case incorporates a direct, automatic relation between bank and client as does the patent put forward.

A banking system performs service communication with a customer service system through an information interaction platform, and the information interaction platform comprises a banking front-end system, a customer front-end system and a communication network, wherein the customer service system and the banking system are respectively connected with the customer front-end system and the banking front-end system.

The method comprises the following steps:

One of the service systems initiates a se vice request to the corresponding front-end system, and the service request includes a requested party and data; the corresponding front-end system sends the service request and the data to the front-end system of the requested party through the communication network according to the stated protocol; the front-end system of the requested party receives and retransmits the service request and the data to the corresponding serve system for processing, and the message transmitted between the front-end systems every time.

Another antecedent studied refers to the patent:

US2002188565 “Client terminal device product, bank server apparatus, information transmitting program, transmitting/receiving program”,

The invention provides an Internet banking system which can present services more familiar to daily life of individual users, and a bank server apparatus, etc. which can limit available banking services depending on user attributes.

From the viewpoint of security, the invention reduces risks of information leak from a client terminal device to third persons and unauthorized accesses from third persons.

Banking software for connection to the bank server apparatus is installed in the client terminal device.

The banking software can display a screen transfer, etc. in the off-line condition.

The banking software prepares transaction instruction data from information entered by the user on the displayed screen and temporarily holds it in the client terminal device.

When the client terminal device is connected to the bank server apparatus, the held data is uploaded to the bank server apparatus.

In the client terminal device, application software can be utilized in linkage with the banking software so as to display the contents of an electronic bankbook.

As examples of the application software, household account-book software, petty cashbook software, etc. can be provided to users.

This does not however amount to an automatic relation between bank/client when not present and which immediately implements a previously arranged operation with a simple click, as in the invention proposed.

The inventor is not aware of further notable precedents or any containing the specifications, innovations and advantage of the patent it is wished to register.

### DESCRIPTION OF THE DRAWINGS

For a better understanding of the invention, a page of plans it attached, showing the following.

FIG. 1. Diagram of tables showing the operation of the method.

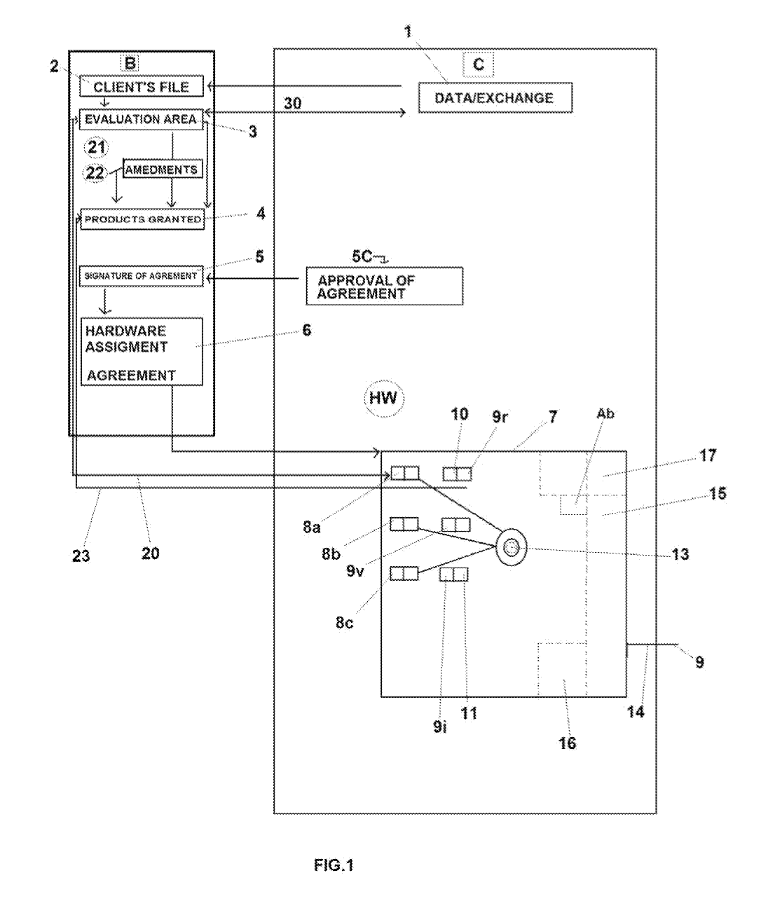

### A PREFERRED EMBODIMENT OF THE INVENTION

The invention proposed refers to a method and resources for direct, automatic operations between bank and client so that, with a simple click of a device installed in the client's domicile, a previously arranged Financial operation can be completed automatically, without need for travel, personal presence or negotiation.

More specifically, the method begins when a client (C) assigns data (1) to a banking institution, henceforth the bank (B), which the bank (B) uses to open a client file (2).

The client file (2) is sent to the evaluation area (3), from where the client (C) may be asked to enlarge the data (30).

With all these data and the Client/product algorithm (A1) created by the bank for this type of operation, the list of pre-approved products (4) is drawn up and the client is informed for the signing of the contract/agreement (5).

Said contract/agreement defines the options (8) the client has, already approved in their direct, remote relation with the bank.

By way of example, these options may be:
Option a.—payment of this month's credit card charges will be just 50%
Option b.—this quarter's mortgage payment is transferred to the following quarter.
Option c.—this month's salary payment is brought forward 15 days . . .
Plus any more options client (C) agrees with bank (B) and which are approved.

Once the client accepts the contract (5C), the signing of the contract/agreement (5) follows, at which point the client is provided with an electronic device (HW) that allows direct, automatic connection between client (C) and bank (B) thanks to an electronic circuit (15) which activates a communications algorithm (Ab), using pre-loaded software (17).

This electronic device (HW), located in the domicile of the client (C) consists of a parallelepiped, straight, rectangular housing with rounded edges (7) on whose upper surface a number of two-position keys are seen—(8a), (8b), (8c), etc.—associated with the various options given by the bank.

Also, alongside each option key (8), there are an equal number of light windows (9) each with two luminous leds (9), one green (11) and the other red (12).

The device also has a cent al button (13) which triggers the order and, on one side, a connection (14) to the electricity network.

Inside, the device has at least one electronic circuit (15) housing pre-loaded software (17) and a set of rechargeable batteries (16) to supply the device in case of an external electrical supply outage.

The procedure to seek one of options (8) granted by the bank is as simple as setting key (8) to the “on” position and pushing the central button (13).

At that point, if the order (20) is received by the bank, the green led (10) comes on to indicate that the operation has been completed.

The red light (11) comes on immediately, showing that this operation has not been authorised to be repeated.

When the system once more authorises this operation, the associated red light (11) of the device (HW) goes off.

The client (C) order produces a double issue (20) to the bank (B) because, while the bank informs the client (C) that the operation has been completed, it sends an order to the modifications department (21) which, as a result of this operation, sends the related order (22) to the department of products granted (4) which immediately modifies the conditions of the products granted and sends a message (23) to the HW device, and the red led (11) linked to the option (9) chosen comes on.

When the conditions of the option selected are changed, the bank (B) switches the red led off (11), indicating to the client that it can once more make use of that option.

It must be emphasised that all these operations between bank (B) and client (C) are almost instantaneous thanks to the communications protocol between the algorithms of the bank (A1) and the (Ac) of the (HW) device installed in the client's domicile.

Having sufficiently described the nature of the invention and its practical implementation, it must be recorded that the specifications indicated above and represented in the attached drawings may be modified in detail provided that this does not alter their fundamental principles established in the previous paragraphs and summarised in the following claims.

1. A method for direct, automatic operations between bank and client whereby, with a simple click on a device installed in the client's domicile, a previously arranged financial operation can be run automatically, comprising the following steps
a client (C) ions data (1) to a banking institution
the bank (B) opens a client file (2), with this information which is passed on to the evaluation area (3) including extra data (30) if necessary,
the Client/Product algorithm (A1) created by the bank for this type of operation, drawns up a list of pre-approved products (4) and the client is informed, for the signing of the contract/agreement (5).
the client accepts the contract (5C), and signs the contract/agreement (5)
the client is provided with an electronic device (HW) that allows direct, automatic connection between client (C) and bank (B) thanks to an electronic circuit (15) which activates a communications algorithm (Ab), using pre-loaded software (17).

2. An electronic device (HW) with preloaded software (17) and a communications algorithm (Ac) to perform the operations described in claim 1 and where the device comprises:
a straight, rectangular, parallelepiped casing with rounded edges (7) on whose upper surface a number of two-position keys are seen—(8a), (8b), (8c)—associated with the various options given by the bank
light windows (9) alongside each option key (8), with two luminous leds (9), one green (11) and the other red (12),
a central button (13), which triggers the order
a connection (14) to the electricity network on one side of the casing (7)
an electronic circuit (15) inside the casing (7) housing pre-loaded software (17) and a set of rechargeable batteries (16) to supply the device in case of an external electrical supply outage.

3. A method according to claim 1 and characterised because the way to seek the options (8) granted by the bank consists of setting the key (8) to the “on” position and pushing the central button (13) at which point, if the order (20) is received by the bank, the green led (10) comes on to indicate that the operation has been completed and the red light (11) comes on immediately after, showing that this operation has not been authorised to be repeated.

4. A method according to claim 3 and characterised because, when the conditions of the option selected change, the bank (B) switches the red led off (11) in the device (HW), indicating to the client that it can once more make use of that option.

5. A method according to claim 4 and characterised because the client's order generates a simultaneous double action in the bank because, while the bank informs the client (C) that the operation has been completed, it sends an order to the modifications department (21) which, as a result of this operation, sends the related order (22) to the department of granted products (4) which immediately modifies the conditions of the products granted and sends a message (23) to the HW device, and the red led (11) linked to the option chosen comes on.

6. Method according to claim 5 and characterised because all the operations between bank (B) and client (C) are virtually instantaneous, thanks to the communications protocol between the algorithms of the bank (A1) and of the client (Ac) in the HW device installed in the client's domicile.
